(19) United States
(12) Patent Application Publication
(10) Pub. No.: US 2025/0112497 A1
(43) Pub. Date: Apr. 3, 2025

(54) MULTI-ANGLE ROTATABLE MULTI-FUNCTION WIRELESS CHARGER

(71) Applicant: Shenzhen Autige Technology Co., Ltd, Shenzhen (CN)

(72) Inventor: Ran She, Shenzhen (CN)

(21) Appl. No.: 18/407,044

(22) Filed: Jan. 8, 2024

(30) Foreign Application Priority Data
Sep. 28, 2023 (CN) 202322645790.6

(51) Int. Cl. H02J 50/10; H02J 7/00; H02J 50/00; H02J 50/40

(52) U.S. Cl. CPC H02J 50/10; H02J 7/0013; H02J 7/0042; H02J 50/005; H02J 50/40

(57) ABSTRACT

A multi-angle rotatable multi-function wireless charger includes a first charging module for providing wireless charging functions to low-power electrical appliances: the first charging module includes a charging bottom case, a rotating charging plate and a stop marble; the rotating charging plate is closed on the charging bottom case, and the rotating charging plate and the charging bottom case can be rotatably connected. During the rotation of the rotating charging plate, the charging bottom case and the rotating charging plate always maintain electrical conduction; the stop marble is set in the space formed by the charging bottom case and the rotating charging plate, and its bottom is connected to the charging bottom case. The top of the stop marble extends toward the rotating charging plate and is a retractable support for the rotating charging plate.

### CROSS REFERENCE TO RELATED APPLICATIONS

This application claims foreign priority of Chinese Patent Application No. 202322645790.6, filed on Sep. 28, 2023 in the China National Intellectual Property Administration, the disclosures of all of which are hereby incorporated by reference.

### TECHNICAL FIELD

The utility model belongs to the technical field of wireless charging, and particularly relates to a wireless charger.

### BACKGROUND OF THE PRESENT INVENTION

The wireless charger provides a special power supply technology, which is equipped with a charging coil. After the charging coil is connected to an external alternating power supply, it converts the alternating current provided by the external alternating power supply into an alternating magnetic field. Correspondingly, the electrical appliance is also equipped with a corresponding charging coil. When the electrical appliance is brought close to the wireless charger, the corresponding charging coil on the electrical appliance will also enter the alternating magnetic field. The charging coil entering the alternating magnetic field will be affected by the alternating magnetic field to generate an induced current. This enables contactless charging of electrical appliances by the wireless charger.

Wireless chargers are often used in charging scenarios for digital products. In recent years, with the rapid development of technology, there are more and more types of digital products. Different digital products have different appearance shapes, power supply requirements, and application scenarios. Users are also increasingly demanding wireless chargers for their use. Wireless chargers that are more flexible to use, smaller in appearance, and easier to carry are more popular among users.

Wireless chargers in the existing technology mostly make improvements in the portability of the charger itself. Take the wireless charger provided in a Chinese patent application No. 201320552018.3 as an example. In Chinese patent application No. 201320552018.3, the wireless charger includes a base and a charging plate. The charging plate is foldably connected to the base through a rotary connection structure. The charging plate or the base is provided with a fixed structure for fixing the charging equipment. When carrying, the charging plate is folded on the base and stored; when in use, the charging plate can rotate around the rotating connection structure and be in a folded state with the base, that is, tilt upward. At this time, the charging device such as a smartphone is placed on the inclined charging plate, and the user can charge and use the charging device at the same time. The technical solution disclosed in the patent application document is to improve the structure of the wireless charger to make it foldable, thereby obtaining a more portable wireless charger.

It should be pointed out that when the wireless charger in the above-mentioned patent application documents is applied to actual life, since it only has one charging position, and the orientation of the charging position is relatively fixed, the charger will only be able to charge one kind of digital product. When charging, the charger also has strict requirements for its placement position. Meanwhile, because the charger does not have a steering function, once the placement position of the charger is determined, the position and orientation of its charging position will also be determined. It is not very flexible and inconvenient to use.

### CONTENTS OF THE PRESENT INVENTION

In order to solve the above problems, the purpose of this utility model is to provide a multi-angle rotatable multi-function wireless charger. When using the wireless charger, the user can manually adjust the rotation angle, which is more convenient to use.

Another purpose of the present utility model is to provide a multi-function wireless charger that is compact in size, easy to carry and use, adaptable to more application scenarios, and more convenient to provide users with more diverse wireless charging options.

In order to achieve the above purpose, the technical solution of the present utility model is as follows:

A multi-angle rotatable multi-function wireless charger, which includes a first charging module for providing wireless charging functions to low-power electrical appliances:

The first charging module includes a charging bottom case, a rotating charging plate and a stop marble; the rotating charging plate is closed on the charging bottom case. And the rotating charging plate and the charging bottom case can be rotatably connected. During the rotation of the rotating charging plate, the charging bottom case and the rotating charging plate always maintain electrical conduction; the stop marble is set in the space formed by the charging bottom case and the rotating charging plate, and its bottom is connected to the charging bottom case. The top of the stop marble extends toward the rotating charging plate and is a retractable support for the rotating charging plate.

Further, the charging bottom case includes a bottom case, a main circuit board and several conductive elastic pieces; the main circuit board is arranged on the bottom case and is connected to the bottom case. The conductive elastic pieces are set on the main circuit board and are arranged in cooperation with the main circuit board. Moreover, the lower part of each conductive elastic piece is connected to the main circuit board. And the upper part of each conductive elastic piece extends toward the direction of the rotating charging plate; each of the conductive elastic pieces maintains electrical conduction with the main circuit board.

Further, the charging bottom case also includes a bottom case fixed cover, which is arranged above the main circuit board and connected to the bottom case. The bottom case fixed cover and the bottom case are enclosed to form a suitable accommodation space for the main circuit board; a power transmission groove corresponding to the conductive elastic piece is also provided on the bottom case fixed cover, and the conductive elastic piece extends from the power transmission groove.

Further, the stop marble includes a stop spring and a stop bead; the stop spring is arranged on the bottom case fixed cover. Its lower end is connected to the bottom case fixed cover and its upper end extends. The stop bead is arranged on the top of the stop spring and connected to the stop spring.

Further, the rotating charging plate includes a rotating plate and a rotating column; the lower part of the rotating column is connected to the bottom case fixed cover, and its upper part extends. The rotating plate is connected to the rotating column; the rotating plate and the bottom case fixed cover are enclosed to form an accommodation space adapted to the stop marble, and the stop bead closely resists the rotating plate.

Further, the rotating plate includes a plate body, a rotation hole and a stop lower edge; the rotation hole is adapted to the rotation column and opened on the plate body; the stop lower edge is arranged on the lower part of the plate body and integrally connected with the plate body; stop grooves are evenly provided at the stop lower edge. After the plate body stops rotating, the stop bead is fitted and embedded in the stop groove.

Further, the rotating charging plate also includes a charging circuit board and a first charging coil; the charging circuit board is arranged between the rotating plate and the bottom case fixed cover. The conductive elastic piece resists the charging circuit board and maintains electrical conduction with the charging circuit board. The first charging coil is arranged above the rotating plate and connected to the rotating plate; the first charging coil is electrically connected to the charging circuit board.

If the stop lower edge is set to be round, regular, and neatly wavy, then after the rotating disk is connected to the bottom case fixed cover through the rotating column, if the user does not twist the rotating charging plate, the stop bead will be affected by the force of the stop spring and tightly press against the bottom of a stop groove at the stop lower edge; and when the user holds the bottom case with one hand and the rotating charging plate with the other hand and twists the rotating plate, the plate body drives the stop lower edge to rotate together, and the wavy stop lower edge of the stop bead is squeezed from the top of the previous wave to the bottom of the next wave. The stop spring repeatedly compresses and releases, keeping the stop bead always tightly against the stop lower edge. During the entire rotation process, “a click, click” sound is emitted, giving the user a sense of frustration in their hands. Once the user twists the rotating plate to a satisfactory angle and stops twisting, the stop bead is continuously affected by the force of the stop spring, resists the stop lower edge, and presses tightly against the bottom of the stop groove. The bottom case and the rotating charging plate are stuck and do not rotate relative to each other, ensuring that the electrical appliance placed on the rotating charging plate can safely complete the entire charging process.

Meanwhile, the wireless charger also includes a second charging module for providing wireless charging functions to medium-power electrical appliances. The second charging module is disposed above the first charging module and hingedly connected to the first charging module. The second charging module maintains electrical conduction with the first charging module.

Further, the wireless charger also includes a third charging module for providing wireless charging functions to relatively high-power electrical appliances. The third charging module is disposed above the second charging module and hingedly connected to the second charging module; the third charging module also maintains electrical conduction with the first charging module.

With a suitable hinge structure, the user can manually adjust the folding state of the wireless charger. When the wireless charger is in a fully expanded state, the first charging module, the second charging module and the third charging module are in the expanded state, the overall appearance is a stretched “Z” shape. The user can choose to place low-power electrical appliances such as wireless earphones at the first charging module and have them charged by the first charging module. Place medium-power electrical appliances such as smart watches or smart bracelets and have them charged by the second charging module. Place electrical appliances such as mobile phones or tablets at the third charging module and have them charged by the third charging module. The user can also choose to move only the third charging module or only the second and third charging modules to use their partial charging functions. When the wireless charger is in a fully folded state, it is in the shape of a small block. At this time, the third charging module located at the top is still open to the electrical appliances, and the user can also use it to wirelessly charge the corresponding electrical appliances. During the above-mentioned folding state adjustment process, the rotation functions between the charging bottom case and the charging rotating plate in the first charging module are not affected, and can be used in combination at the same time, making it convenient for the user to adjust the posture of the entire wireless charger to adapt to more electricity usage scenarios and meet more electrical appliance charging needs.

The advantage of this utility model is that compared with the existing technology, the wireless charger provided in this utility model is compact in structure and size, easy to use, and widely used. It can be applied to more charging scenarios and meet the diverse charging needs of users.

### DESCRIPTION OF THE DRAWINGS

FIG. 1 is a schematic diagram of the overall structure of the multi-angle rotatable multi-function wireless charger provided in this embodiment in a folded state.

FIG. 2 is a schematic diagram of the overall structure of the multi-angle rotatable multi-function wireless charger provided in this embodiment in an unfolded state.

FIG. 3 is a schematic diagram of the internal structure of the first charging module in the multi-angle rotatable multi-functional wireless charger provided in this embodiment.

FIG. 4 is an exploded view of the first charging module in the multi-angle rotatable multi-function wireless charger provided in this specific embodiment.

FIG. 5 is a schematic structural diagram of the rotating plate in the multi-angle rotatable multi-function wireless charger provided in this specific embodiment.

FIG. 6 is a schematic structural diagram of the bottom case fixed cover of the multi-angle rotatable multi-function wireless charger provided in this specific embodiment.

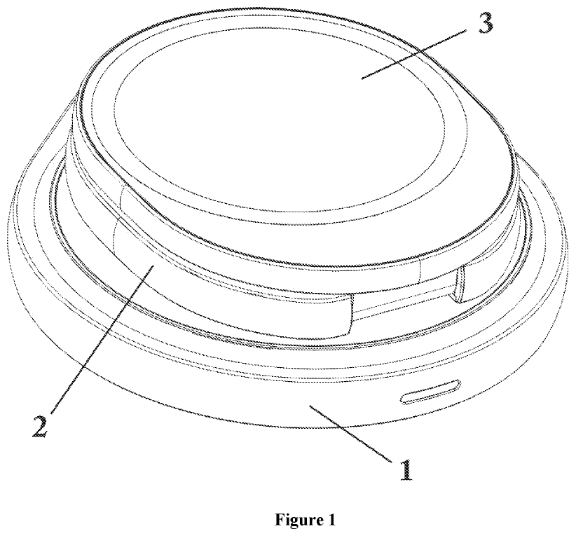

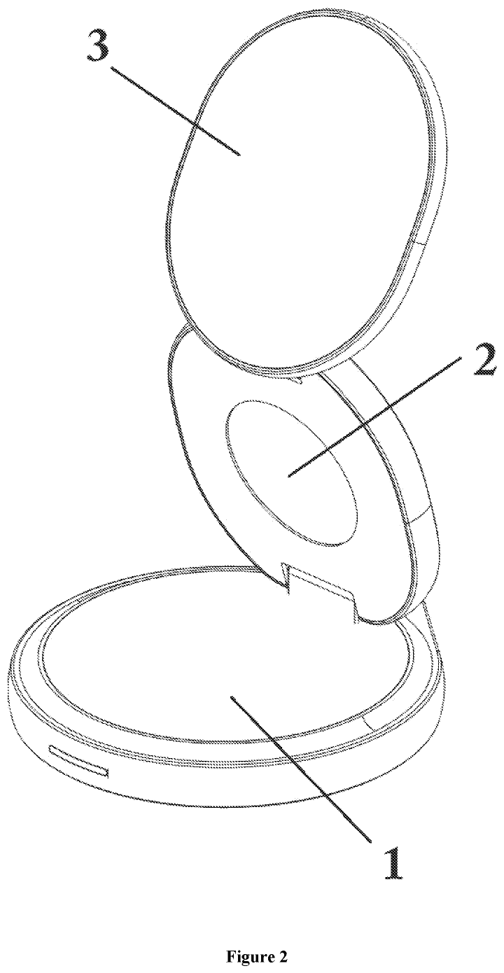

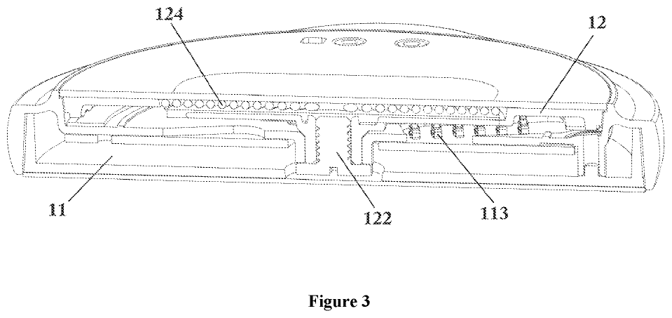

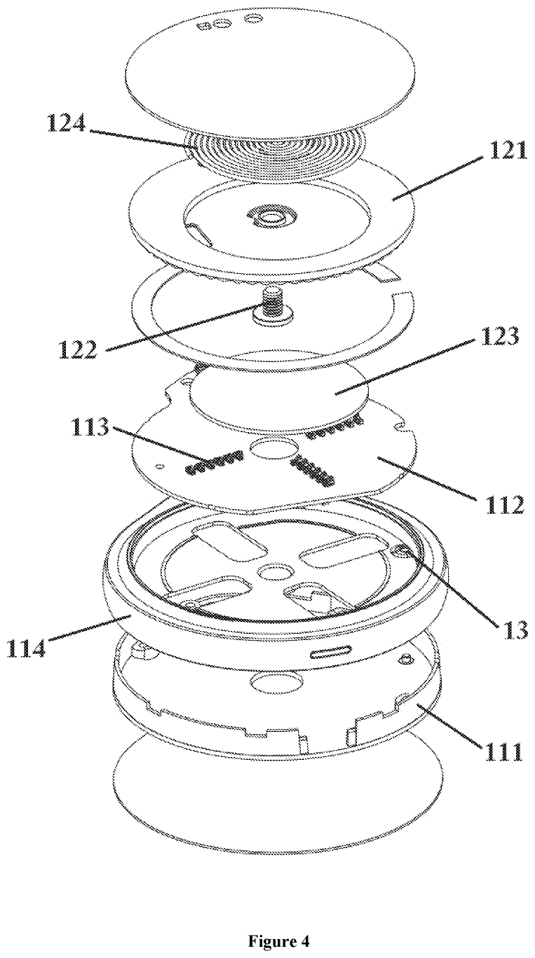

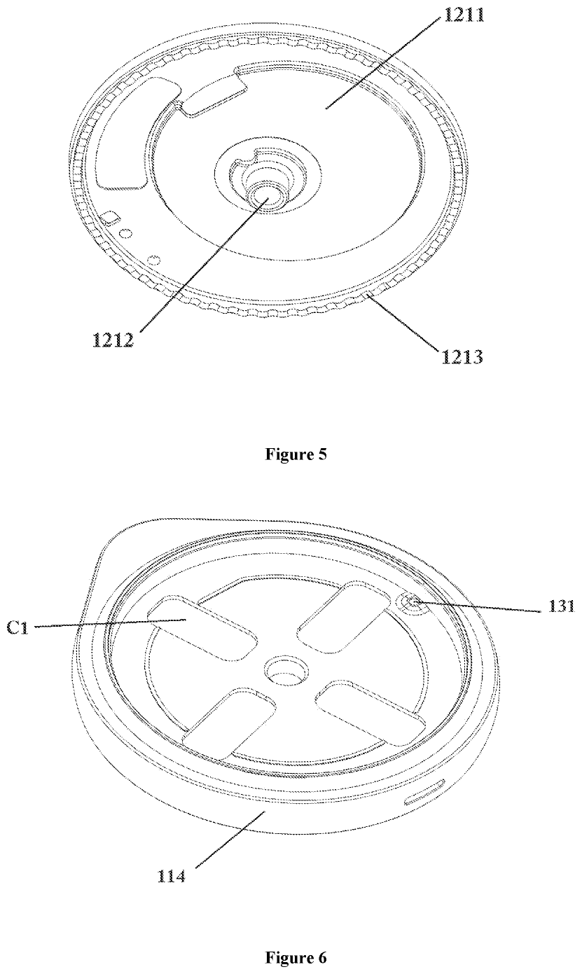

### DETAILED DESCRIPTION OF PREFERRED EMBODIMENTS

In order to make the purpose, technical solutions and advantages of the present utility model clearer, the utility model will be further described in detail below with reference to the drawings and embodiments. It should be understood that the specific embodiments described here are only used to explain the present invention and are not intended to limit the present invention.

In order to achieve the above purpose, the technical solution of the present invention is as follows:
See picture 1-6:

In this specific embodiment, a multi-angle rotatable multi-function wireless charger is provided. The wireless charger includes a first charging module 2 for providing wireless charging functions to low-power 2.5 W-5W□ electrical appliances, a second charging module 1 for providing wireless charging functions to medium-power 3 W-15 W electrical appliances, and a third charging module 3 for providing wireless charging functions to relatively high-power 7.5 W-20 W□ electrical appliances.

Among them, the second charging module 1 is disposed above the first charging module 2 and is hingedly connected to the first charging module 2. The second charging module 1 maintains electrical conduction with the first charging module 2. The third charging module 3 is disposed above the second charging module 1 and is hingedly connected to the second charging module 1; the third charging module 3 also maintains electrical conduction with the first charging module 2.

Specifically, the first charging module 2 includes a charging bottom case 11, a rotating charging plate 12 and a stop marble 13; the rotating charging plate 12 is closed on the charging bottom case 11. And the rotating charging plate 12 and the charging bottom case 11 can be rotatably connected. During the rotation of the rotating charging plate 12, the charging bottom case 11 and the rotating charging plate 12 always maintain electrical conduction; the stop marble 13 is set in the space formed by the charging bottom case 11 and the rotating charging plate 12, and its bottom is connected to the charging bottom case 11. The top of the stop marble 13 extends toward the rotating charging plate 12 and is a retractable support for the rotating charging plate 12.

Further, in this specific implementation, the charging bottom case 11 includes a bottom case 111, a main circuit board 112 and several conductive elastic pieces 113; the main circuit board 112 is arranged on the bottom case 111 and is connected to the bottom case 111. The conductive elastic pieces 113 are arranged on the main circuit board 112 and are arranged in cooperation with the main circuit board 112. Moreover, the lower part of each conductive elastic piece 113 is connected to the main circuit board 112. And the upper part of each conductive elastic piece 113 extends toward the direction of the rotating charging plate 12; each of the conductive elastic pieces 113 maintains electrical conduction with the main circuit board 112.

Further, in this specific implementation, the charging bottom case 11 also includes a bottom case fixed cover 114, which is arranged above the main circuit board 112 and is connected to the bottom case 111. The bottom case fixed cover 114 and the bottom case 111 are enclosed to form a suitable accommodation space for the main circuit board 112; a power transmission groove C1 corresponding to the conductive elastic piece 113 is also provided on the bottom case fixed cover 114, and the conductive elastic piece 113 extends from the power transmission groove C1.

Further, in this specific implementation, the stop marble 13 includes a stop spring (not shown in the figure) and a stop bead 131; the stop spring is arranged on the bottom case fixed cover 114. Its lower end is connected to the bottom case fixed cover 114 and its upper end extends. The stop bead 131 is arranged on the top of the stop spring and connected to the stop spring.

Further, in this specific implementation, the rotating charging plate 12 includes a rotating plate 121 and a rotating column 122; the lower part of the rotating column 122 is connected to the bottom case fixed cover 114, and its upper part extends. The rotating plate 121 is connected to the rotating column 122; the rotating plate 121 and the bottom case fixed cover 114 are enclosed to form an accommodation space adapted to the stop marble 13, and the stop bead 131 closely resists the rotating plate 121.

Further, in this specific implementation, the rotating plate 121 includes a plate body 1211, a rotation hole 1212 and a stop lower edge 1213; the rotation hole 1212 is adapted to the rotation column 122 and opened on the plate body 1211; the stop lower edge 1213 is arranged on the lower part of the plate body 1211 and integrally connected with the plate body 1211; stop grooves C2 are evenly provided at the stop lower edge 1213. After the plate body 1211 stops rotating, the stop bead 131 is fitted and embedded in the stop groove C2. □

Further, in this specific implementation, the rotating charging plate 12 also includes a charging circuit board 123 and a first charging coil 124; the charging circuit board 123 is arranged between the rotating plate 121 and the bottom case fixed cover 114. The conductive elastic piece 113 resists the charging circuit board 123 and maintains electrical conduction with the charging circuit board 123. The first charging coil 124 is arranged above the rotating plate 121 and connected to the rotating plate 121; the first charging coil 124 is electrically connected to the charging circuit board 123. The above are only preferred embodiments of the present utility model and are not intended to limit the present utility model. Any modifications, equivalent substitutions and improvements made within the spirit and principles of the present utility model shall be included in the protection scope of the present utility model.

We claim:

1. A multi-angle rotatable multi-function wireless charger, characterized in that the wireless charger includes a first charging module for providing wireless charging functions to low-power electrical appliances:
The first charging module includes a charging bottom case, a rotating charging plate and a stop marble; the rotating charging plate is closed on the charging bottom case. And the rotating charging plate and the charging bottom case can be rotatably connected. During the rotation of the rotating charging plate, the charging bottom case and the rotating charging plate always maintain electrical conduction; the stop marble is set in the space formed by the charging bottom case and the rotating charging plate, and its bottom is connected to the charging bottom case. The top of the stop marble extends toward the rotating charging plate and is a retractable support for the rotating charging plate.

2. The multi-angle rotatable multi-function wireless charger according to claim 1, characterized in that the charging bottom case includes a bottom case, a main circuit board and several conductive elastic pieces; the main circuit board is arranged on the bottom case and is connected to the bottom case. The conductive elastic pieces are set on the main circuit board and are arranged in cooperation with the main circuit board. Moreover, the lower part of each conductive elastic piece is connected to the main circuit board. And the upper part of each conductive elastic piece extends toward the direction of the rotating charging plate; each of the conductive elastic pieces maintains electrical conduction with the main circuit board.

3. The multi-angle rotatable multi-function wireless charger according to claim 2, characterized in that the charging bottom case also includes a bottom case fixed cover, which is arranged above the main circuit board and connected to the bottom case. The bottom case fixed cover and the bottom case are enclosed to form a suitable accommodation space for the main circuit board; a power transmission groove corresponding to the conductive elastic piece is also provided on the bottom case fixed cover, and the conductive elastic piece extends from the power transmission groove.

4. The multi-angle rotatable multi-function wireless charger according to claim 3, characterized in that the stop marble includes a stop spring and a stop bead; the stop spring is arranged on the bottom case fixed cover. Its lower end is connected to the bottom case fixed cover and its upper end extends. The stop bead is arranged on the top of the stop spring and connected to the stop spring.

5. The multi-angle rotatable multi-function wireless charger according to claim 4, characterized in that the rotating charging plate includes a rotating plate and a rotating column; the lower part of the rotating column is connected to the bottom case fixed cover, and its upper part extends. The rotating plate is connected to the rotating column; the rotating plate and the bottom case fixed cover are enclosed to form an accommodation space adapted to the stop marble, and the stop bead closely resists the rotating plate.

6. The multi-angle rotatable multi-function wireless charger according to claim 5, characterized in that the rotating plate includes a plate body, a rotation hole and a stop lower edge; the rotation hole is adapted to the rotation column and opened on the plate body; the stop lower edge is arranged on the lower part of the plate body and integrally connected with the plate body; stop grooves are evenly provided at the stop lower edge. After the plate body stops rotating, the stop bead is fitted and embedded in the stop groove.

7. The multi-angle rotatable multi-function wireless charger according to claim 6, characterized in that the rotating charging plate also includes a charging circuit board and a first charging coil; the charging circuit board is arranged between the rotating plate and the bottom case fixed cover. The conductive elastic pieces resist the charging circuit board and maintain electrical conduction with the charging circuit board. The first charging coil is arranged above the rotating plate and connected to the rotating plate; the first charging coil is electrically connected to the charging circuit board.

8. The multi-angle rotatable multi-function wireless charger according to claim 1, characterized in that the wireless charger also includes a second charging module for providing wireless charging functions to medium-power electrical appliances. The second charging module is disposed above the first charging module and hingedly connected to the first charging module. The second charging module maintains electrical conduction with the first charging module.

9. The multi-angle rotatable multi-function wireless charger according to claim 8, characterized in that the wireless charger also includes a third charging module for providing wireless charging functions to relatively high-power electrical appliances. The third charging module is disposed above the second charging module and hingedly connected to the second charging module; the third charging module also maintains electrical conduction with the first charging module.
